(19) United States
(12) Patent Application Publication
(10) Pub. No.: US 2019/0100832 A1
(43) Pub. Date: Apr. 4, 2019

(54) METHOD FOR MANUFACTURING A COATING

(71) Applicant: General Electric Technology GmbH, Baden (CH)

(72) Inventors: Johannes Clemens SCHAB, Dresden (DE); Sophie Betty Claire DUVAL, Zurich (CH); Piero Daniele GRASSO, Niederweningen (CH); Julien Rene Andre ZIMMERMANN, Neuenhof (CH)

(21) Appl. No.: 16/125,986

(22) Filed: Sep. 10, 2018

(30) Foreign Application Priority Data
Sep. 29, 2017 (EP) 17193982.0

(51) Int. Cl. C23C 4/129; C23C 4/10; C23C 28/04; F01D 5/28; F01D 11/12

(52) U.S. Cl. CPC C23C 4/129; C23C 4/10; C23C 28/042; F01D 5/288; F05D 2300/611; F05D 2230/90; F05D 2300/2118; F05D 2300/212; F01D 11/122

(57) ABSTRACT

A method for generating coatings is disclosed. The method involves applying a flame spray technique. A metallic powder material is provided to the flame, and the process parameters of the flame spray process are chosen such as to achieve a metallic coating layer with a distinct surface roughness. In a subsequent process phase, a non-metallic material may be disposed on the rough metallic layer by flame spraying. The non-metallic layer effectively interlocks with the roughness of the metallic layer. The method may be carried out with hand-held equipment.

### TECHNICAL FIELD

The present disclosure relates to a method for manufacturing a coating as set forth in claim 1.

### BACKGROUND OF THE INVENTION

Coatings on mechanical components, in particular on engine components, are widely used in the art of engineering. A typical, while non-limiting instance is gas turbine engineering. For instance, components in the hot gas path of a gas turbine engine may be coated with thermal barrier coatings in order to reduce the metal temperature and also in some cases with environmental barrier coatings in order for the component to better withstand aggressive chemicals from the fuel. In other instances abradable coatings may be used on rotating and/or stationary components at their mutual interface. Hardface coatings may be used on location where wear might occur.

An issue in manufacturing coatings is to ensure that the coating or the coating layers, for instance the top coating layer, remains firmly connected to the substrate. Often, the pairing of the coating material and the substrate is such that the chemical bonding between the both is weak. Moreover, when the thermal expansion coefficient of adjacent coating layers or a coating layer and a substrate is different, shear forces may occur at the interface and have a negative impact on the bonding interface. Specific bond coat layers may be provided. In any case, in manufacturing a coating layer on a rough surface the adherence of the coating layer may significantly be increased due to mechanical interlocking effects. It may be desirable to manufacture a surface with a distinct surface roughness to provide a coating layer on the rough interface.

Although sophisticated coating systems and coating materials are available, it is apparent that in a long-term operation in a harsh environment, such as in a gas turbine engine, in the presence of flue gases at temperatures of several hundred ° C., and moreover in the presence of steep temperature gradients upon start-up, shut-down, or transient load changes, coatings may deteriorate and show defects after months and years of operation, i.e. several thousand operating hours. The component may then, if it is all in all structurally intact, be refurbished. One, or sometimes the only required, refurbishing step is refurbishing the coating.

Depending on the specific application, the coatings to be refurbished may be comparatively thick. For one instance, a ceramic thermal barrier coating may be 1.5 mm thick, and even thicker coatings may be found. Abradable coatings may, by their nature, be several millimeters thick. The skilled person will appreciate that when repairing a coating it must be ensured that the applied repair coating sufficiently firmly adheres to the substrate.

Thus, there is a need for economically feasible methods of refurbishing a coating of an engine component or other mechanical component. For instance, if a coating is only locally damaged, it may be desirable to only locally repair the damaged area. US 2005/0235493 for one instance discloses a method in which the substrate surface of a coating defect is cleaned and the surface of the defect is mechanically roughened. Subsequently, a bond coat is applied to the roughened surface, and a top coat repair is placed on top of the bond coat repair. The method disclosed in US 2005/0235493 requires the abrasive cleaning step on the one hand, and further a roughening step which may comprise knurling, abrasive spraying, and/or laser grooving. If it is desired to conduct the coating repair on site, i.e. without the need to ship the worn component to a workshop, or even in situ, with the component installed in the engine. It may further be the case that all these steps may need to be performed with limited handling space, and all the required equipment needs to be moved to the location of the installed worn component, with all the restrictions due to the constricted space conditions.

US 2005/0003097 discloses a thermal spray coating method, wherein the melting point of the material to be sprayed is reduced in doping the thermal barrier coating material with a melting point depressant material in order to allow the thermal barrier coating material to be applied by a low velocity flame spray process.

### SUMMARY OF INVENTION

It is an object of the present disclosure to disclose a method of the kind initially mentioned. In one aspect of the disclosure, the method shall be such as to produce a coating layer having a distinct surface roughness, such as to, for instance enable a thorough interlocking of a further coating layer manufactured thereon. In one aspect, the method shall be suitable to be used as a process for the repair of local coating defects. In another aspect, the method shall be disclosed such that it is possible to manually carry out the method. Of course, establishing the coating and/or repair method as an automated method is not excluded; however, the method shall be such as to tolerate a less accurate application, which may occur when the method is manually performed on site, or even at an installed component in situ. In a further, more specific aspect, the method shall be such that the required equipment may be supplied and safely operated under constricted space conditions. That is, in other words, as little devices as possible should be required, and the required devices should be as small and mobile as possible.

This is achieved by the subject matter set forth in claim 1.

Accordingly, disclosed is a method for manufacturing a coating on a component. The method may in particular embodiments be applied for and constitute a method for the repair of coating defects, in particular local coating defects. The method generally comprises providing an oxidizer fluid flow and a combustion fluid flow to a spray device, combusting the combustion fluid flow with the oxidizer fluid flow, thereby generating a flame emanating from the spray device, and providing a shielding fluid flow around the flame. The shielding fluid flow may in particular instances be a flow of air. A supply mass flow of powder material is supplied into the flame, thus providing a flow of molten material inside the flame. The flame with the dispersed flow of molten material inside is directed towards a surface of a workpiece, thereby depositing the molten material on the surface and generating a coating. It is understood that the shielding fluid flow also serves as a coolant flow which assists in enclosing the flame in a defined space, and quenches temperature outside the flame. The method comprises directing the flame towards a surface area of a workpiece. In exemplary embodiments, i.e. when applying the method for the repair of coating defects, the surface area of the workpiece towards which the flame is directed may be a surface area which exhibits a damaged coating. The method further comprises that the powder material which is supplied into the flame comprises a metal, thereby generating a metallic coating layer. The process parameters, while a powder material is supplied into the flame which comprises a metal, are set such as to generate a metallic coating layer with a surface arithmetic mean roughness value Ra equal to or larger than 10 microns, and in more particular embodiments equal to or larger than 13 microns.

### DETAILED DESCRIPTION

The process parameters, while a powder material is supplied into the flame which comprises a metal, may further be set such as to generate a metallic coating layer with combined inclusions of porosity plus oxides of less than or equal to 25% by volume.

The skilled person will readily appreciate, that prior to manufacturing the metallic coating layer the surface area of the workpiece may or may not be treated, such as to, for instance, clean the surface of the substrate and remove oxide layers or debris if needed. Such, the molten metallic material may be applied directly to the substrate material, and achieve a robust bonding.

Further effects and advantages of the disclosed subject matter, whether explicitly mentioned or not, will become apparent in view of the disclosure provided below.

It is noted that within the framework of the present disclosure the use of the indefinite article “a” or “an” does in no way stipulate a singularity, nor does it exclude the presence of a multitude of the named member or feature. It is thus to be read in the sense of “at least one” or “one or a multitude of”.

A subsequent process phase may be applied subsequent to generating the metallic coating layer. Said subsequent process phase comprises selecting a further powder material to be supplied to the flame and supplying said further powder material into the flame, and directing the flame towards the surface of the previously generated layer, in particular embodiments of the previously generated metallic layer, thereby generating a further coating layer on the previously coating layer. The further powder material may in particular comprise a non-metallic; more in particular ceramic, material.

It is understood that a further coating layer is generated directly on the metallic coating layer.

In that the metallic layer is directly formed with a distinct surface roughness, a subsequently applied further coating layer on the metallic coating layer intermeshes and interlocks effectively with the metallic layer without the need to apply a separate surface roughening step, while the metallic layer in turn effectively bonds to the substrate, as outlined above.

The applied spray technique applied during both process phases, i.e. when a powder material is supplied into the flame which comprises a metal, which may be referred to as the first process phase, and, if applicable, during the subsequent process phase, is known in the art as “flame spraying”. As mentioned above, it comprises providing an oxidizer fluid flow and a combustion fluid flow to a spray device, combusting the combustion fluid flow with the oxidizer fluid flow, thereby generating a flame emanating from the spray device, and providing a shielding fluid flow around the flame. The shielding fluid flow may in particular instances be a flow of air. A powder material flow is supplied into the flame, thus providing a flow of molten material inside the flame. The flame with the dispersed flow of molten material inside is directed towards a surface of a workpiece, thereby depositing the molten material on the surface and generating a coating layer. It is understood that the shielding fluid flow also serves as a coolant flow which assists in enclosing the flame in a defined space, and quenches temperature outside the flame. The oxidizer may in particular instances be pure oxygen. The combustion fluid may in particular instances be acetylene. The mass flows of oxidizer and combustion fluid are in particular such as to achieve a neutral flame, that is, a flame which is neither oxidizing nor reducing or carburizing. In other words, the entire mass flow of oxidizer is consumed by burning the combustion fluid, and the combustion fluid is completely oxidized. In still other words, the mass flows of oxidizer and combustion fluid are set such as to achieve a stoichiometric flame. Oxidation or reduction of the material supplied into the flame, or carbide formation at the high temperature levels, is thus inhibited if not at least largely avoided. Important process parameters may be the powder material supply mass flow, the shielding fluid feed pressure, the oxidizer feed pressure, the combustion fluid feed pressure, the working distance from the exit of the spray device to the workpiece, and the step size. The step size is the offset between two subsequent paths along which the spray device is directed, in other words, the lateral distance along which the spray device is displaced between two subsequent, in particular at least essentially parallel, spray tracks.

The oxidizer or oxygen feed pressure may in the herein disclosed method be generally set to 4.0 bars. The combustion fluid or acetylene feed pressure may in the herein disclosed method be generally set to 0.7 bars.

The metal powder material which is supplied to the flame when generating the metallic coating layer may comprise 80% or more, more in particular 90% or more, of a metal. Percentage contents specified within this document shall generally be understood as percent by mass of the total composition, if not explicitly stated otherwise. Metal, as used in the present context, shall in a broad sense be understood as any metal or metal alloy. In more particular embodiments, the metal powder material which is used when generating the metallic coating layer may entirely consist of a metal. The term “entirely consist” as used in the context of the present disclosure is to be understood as “consisting of the specified material plus residual impurities”. Residual impurities may for instance be present at a mass percentage of 5% or less, more in particular 2% or less, 1% or less, or 0.5% or less, in each case specified as mass-% of the total composition. Said definitions shall also apply for any subsequent recitation of the term “entirely consist” within the present disclosure.

The metal powder material may comprise, for instance at percentages as specified above, or entirely consist of one or more of the following alloys:

A nickel-cobalt-chromium-aluminum-yttrium (NiCoCrAlY) alloy with additions of silicon (Si) and tantalum (Ta).

A nickel--chromium-aluminum-yttrium (NiCrAlY) alloy with additions of silicon (Si) and tantalum (Ta).

A nickel-chromium-aluminum-yttrium (NiCrAlY) alloy with additions of silicon (Si) tantalum (Ta) and boron (B).

A cobalt-nickel-chromium-aluminum-yttrium (CoNiCrAlY) alloy.

A nickel-chromium-aluminum-yttrium (NiCrAlY) alloy.

The further powder material may comprise or entirely consist of at least one of a thermal barrier coating material, and/or environmental barrier coating material, an abradable coating material or a hardface coating material. It is understood, that this list of exemplary materials is given for reference purposes and is not intended to be limiting. The further powder material may comprise 80% or more, more in particular 90% or more, of a non-metallic and/or ceramic material, such as, but not limited to, at least one of a thermal barrier coating material, an environmental barrier coating material, an abradable coating material and a hardface coating material, or may entirely consist of one of said materials, or a mixture of at least two of them.

Certain process parameters when generating the metallic coating layer, or during the first process phase, respectively, individually or in combination with each other, be chosen as follows:

The working distance from an exit of the spray device to the workpiece surface may be chosen in a range from equal to or larger than 160 mm and smaller than or equal to 240 mm when generating the metallic coating layer, or during the first process phase, respectively.

The powder material supply or feed mass flow may be equal to or larger than 40 g/min and smaller than or equal to 70 g/min when generating the metallic coating layer, or during the first process phase, respectively. In more particular exemplary embodiments, the powder material supply mass flow may be equal to or larger than 50 g/min and smaller than or equal to 70 g/min when generating the metallic coating layer, or during the first process phase, respectively.

The shielding fluid feed pressure may be larger than or equal to 1.0 bars and smaller than or equal to 5.0 bars.

The step size may be larger than or equal to 8 mm and smaller than or equal to 12 mm.

In certain exemplary embodiments, a subsequent process phase may be applied wherein the further powder material comprises, for instance 80 mass-% or more or 90 mass-% or more, or entirely consists of, a thermal barrier coating material. This may for non-limiting instances comprise 80 mass-% or more or 90 mass-% or more, or entirely consist, of at least one of alumina—an aluminum oxide material—and/or yttrium-stabilized zirconia. In order to manufacture a coating layer which is intended as a porous thermal barrier coating, certain process parameters may during the subsequent process phase be chosen, individually or in combination with each other, as follows:

The working distance from an exit of the spray device to the workpiece surface may be chosen in a range from equal to or larger than 80 mm and smaller than or equal to 140 mm.

The powder material supply mass flow may be equal to or larger than 15 g/min and smaller than or equal to 30 g/min.

The shielding fluid feed pressure may be larger than or equal to 1.0 bars and smaller than or equal to 3.0 bars.

The step size may be larger than or equal to 3 mm and smaller than or equal to 8 mm.

In further exemplary embodiments, a subsequent process phase may be applied wherein the further powder material comprises, for instance 80 mass-% or more or 90 mass-% or more, or entirely consists of, a ceramic coating material. This may for non-limiting instances comprise, for instance 80 mass-% or more or 90 mass-% or more, or entirely consist of at least one of alumina—an aluminum oxide material—and/or yttrium-stabilized zirconia. In order to manufacture a coating layer which is intended as a dense vertical-cracked thermal barrier coating, certain process parameters may during the subsequent process phase be chosen, individually or in combination with each other, as follows:

The working distance from an exit of the spray device to the workpiece surface may be chosen in a range from equal to or larger than 50 mm and smaller than or equal to 180 mm.

The powder material supply mass flow may be equal to or larger than 12 g/min and smaller than or equal to 18 g/min.

The shielding fluid feed pressure may be larger than or equal to 0.1 bars and smaller than or equal to 1.5 bars.

The step size may be larger than or equal to 2 mm and smaller than or equal to 5 mm.

In still further exemplary embodiments, a subsequent process phase may be applied wherein the further powder material comprises, for instance 80 mass-% or more or 90 mass-% or more, or entirely consist of, an abradable coating material. This may for non-limiting instances comprise, for instance 80 mass-% or more or 90 mass-% or more, or entirely consist of at least one of yttria stabilized zirconia (YSZ) and/or dysprosia stabilized zirconia (DySZ) and/or alumina, an aluminum oxide material. In order to manufacture a coating layer which is intended as an abradable coating, certain process parameters may during the subsequent process phase be chosen, individually or in combination with each other, as follows:

The working distance from an exit of the spray device to the workpiece surface may be chosen in a range from equal to or larger than 50 mm and smaller than or equal to 100 mm.

The powder material supply mass flow may be equal to or larger than 20 g/min and smaller than or equal to 32 g/min.

The shielding fluid feed pressure may be larger than or equal to 1.5 bars and smaller than or equal to 5.0 bars.

The step size may be larger than or equal to 3 mm and smaller than or equal to 8 mm.

In still further exemplary embodiments, a subsequent process phase may be applied wherein the further powder material comprises, for instance 80 mass-% or more or 90 mass-% or more, or entirely consists of an environmental barrier coating material. This may for non-limiting instances comprise, for instance 80 mass-% or more or 90 mass-% or more, or entirely consist of alumina, an aluminum oxide material. In order to manufacture a coating layer which is intended as an environmental barrier coating, certain process parameters may during the subsequent process phase be chosen, individually or in combination with each other, as follows:

The working distance from an exit of the spray device to the workpiece surface may be chosen in a range from equal to or larger than 80 mm and smaller than or equal to 140 mm.

The powder material supply mass flow may be equal to or larger than 15 g/min and smaller than or equal to 30 g/min.

The shielding fluid feed pressure may be larger than or equal to 1.0 bar and smaller than or equal to 3.0 bars.

The step size may be larger than or equal to 2 mm and smaller than or equal to 5 mm.

In specific embodiments, the methods as lined out above may be performed on a locally restricted surface area of a component. This may be the case for the repair of local coating defects. This may also be the case if for instance only an airfoil of a blading member is coated, while the root region is uncoated.

The method as herein disclosed is in particular suited for application on site, i.e. a component to be refurbished needs not necessarily to be shipped to a specialized workshop.

Further, the required thermal spray equipment may be sufficiently small and lightweight, and the method may be sufficiently stable to achieve the specified tolerances upon performing the method, that it may be performed manually, i.e. without bulky and expensive equipment for guiding the tools. However, it is understood that an automated performance of the method is also possible, if such equipment is available and is suitable under the conditions at the location where the method is to be carried out. In even more specific instances, the method may be carried out with handheld devices.

In other aspects, the powder material comprises, for instance 80 mass-% or more or 90 mass-% or more, or entirely consists of a hardface coating material. This may for non-limiting instances comprise, for instance 80 mass-% or more or 90 mass-% or more, or entirely consist of a chromium carbide material, such as e.g. a Cr3C2-NiCr 75/25 material. In order to manufacture a coating layer which is intended as a hardface coating, certain process parameters may during the subsequent process phase be chosen, individually or in combination with each other, as follows:

The working distance from an exit of the spray device to the workpiece surface may be chosen in a range from equal to or larger than 100 mm and smaller than or equal to 220 mm.

The powder material supply mass flow may be equal to or larger than 45 g/min and smaller than or equal to 65 g/min.

The shielding fluid feed pressure may be larger than or equal to 2.0 bars and smaller than or equal to 4.0 bars.

The step size may be larger than or equal to 8 mm and smaller than or equal to 12 mm.

This may in particular be applied directly on the substrate, i.e. without a previously manufactured rough metallic coating layer.

It is understood that in particular embodiments each of the subsequent process phases specified above may be applied directly on the metallic coating layer, such that the resulting further coating layer is generated directly on top of the metallic coating layer of a distinct surface roughness.

It is understood that the features and embodiments disclosed above may be combined with each other. It will further be appreciated that further embodiments are conceivable within the scope of the present disclosure and the claimed subject matter which are obvious and apparent to the skilled person.

### EXEMPLARY MODES OF CARRYING OUT THE TEACHING OF THE PRESENT INVENTION

The skilled person will appreciate the merits of the herein disclosed subject matter to the fullest extend in view of certain exemplary embodiments provided below. It is understood that the examples provided in those embodiments all by no way intended to limit the scope of protection, which is defined by the broadest subject matter covered by the claims.

For instance, the method as herein disclosed may be applied for servicing and the overhaul of a gas turbine engine. The method may be applied for the repair of defective coatings on the hot gas parts components, such as for instance compressor and turbine blades and vanes, burners, combustor tiles, heat shields and so forth. It is understood, that generally thermal barrier coatings are applied to the component in the combustion chamber and the first turbine stages, while for instance environmental barrier coatings may for a non-limiting instance be found in the last turbine stages, and hardface coatings may for instance be applied on contact areas and rubbing areas inside an engine, on burners, and on shroud contact faces. Abradable coatings may for instance be applied on compressor and turbine heat shields. As noted, the examples are not intended to be comprehensive or limiting. During several thousand hours of use in a harsh environment, such coatings deteriorate may exhibit local defects. It is beneficial, in terms of time and cost, if for instance local defects of coatings can be repaired in situ, without the need to dismantle the components and/or the engine.

Further, during inspection, it may be the case that an engine housing needs to be split in cutting the housing. The cut damages coatings of the housing. The housing is re-assembled by welding. At the weld seam, the housing lacks a coating and needs to be locally re-applied.

The method as described above enables for instance on site repair of local coating defects. Spray devices for flame spraying are available which are sufficiently small and lightweight to be manually operated. No heavy or bulky equipment is required directly at the repair site. Furthermore, lines of material supply may be held sufficiently small and flexible. Such characteristics also result in very small space requirements for access to a repair site and operation of the equipment. The method may thus be very flexibly used in a vast number of applications.

In applying the method, a defective area may or may not be cleaned or otherwise prepared for refurbishing the coating before the flame spraying process comes into play. This may include masking of the surface for local surface preparation of the defective location, and surface preparation. It is noted, that after having generated the coating, the refurbished location may be reworked, for instance for coating thickness adaption and/or component recontouring. During the first process phase, a metallic coating layer may be applied to the defective location in directing the flame spray device towards defective location and supplying a metallic powder material into the flame. The powder material may be chosen to entirely consist of one of

a nickel-cobalt-chromium-aluminum-yttrium (NiCoCrAlY) alloy with additions of silicon (Si) and tantalum (Ta),

a nickel--chromium-aluminum-yttrium (NiCrAlY) alloy with additions of silicon (Si) and tantalum (Ta),

a nickel-chromium-aluminum-yttrium (NiCrAlY) alloy with additions of silicon (Si) tantalum (Ta) and boron (B),

a cobalt-nickel-chromium-aluminum-yttrium (CoNiCrAlY) alloy, or

a nickel-cobalt-chromium-aluminum-yttrium (NiCrAlY) alloy,

or a combination of one or more of said alloys. The flame is, in this embodiment, generated in combusting acetylene in pure oxygen. The equivalence ratio of the flame is set such as to achieve a neutral flame which is neither oxidizing nor carburizing, as outlined above. While thus manufacturing a metallic coating layer, the supply or feed pressure of oxygen is set to 4.0 bars, and the supply or feed pressure of acetylene is set to 0.7 bars. The supply or feed pressure of compressed air which is used as shielding air is chosen in a range of equal to 1.0 bar and smaller than or equal to 5.0 bars. The acetylene may at the same time be used as a carrier gas flow to supply the powder material into the flame. The working distance from an exit of the spray device to the workpiece surface is be chosen in a range from equal to or larger than 160 mm and smaller than or equal to 240 mm. Further, in the exemplary embodiment, the mass flow of powder alloy supplied into the flame is chosen to be equal to or larger than 40 g/min and smaller than or equal to 70 g/min. The flame spraying process is carried out with a step size larger than or equal to 8 mm and smaller than or equal to 12 mm. With the chosen process parameters, a metallic coating layer is manufactured with a surface arithmetic mean roughness value Ra equal to or larger than 10 microns, and in more particular embodiments an combinations of process parameter settings equal to or larger than 13 microns, and combined inclusions of porosity plus oxides of less than or equal to 25% by volume. As noted above, in particular on a metallic substrate the metallic layer material is bonded in a way which may be considered somewhat similar to weld cladding. The resulting well-bonded compact, i.e. low porosity, metallic layer with a distinct surface roughness provides an excellent basis for a further coating layer to be disposed thereon.

For one instance, it may be desired to dispose a thermal barrier coating layer on the metallic coating layer. In this instance, the flame spraying process is in a subsequent process phase carried out with a powder material consisting of alumina or yttrium stabilized zirconia, or a mixture thereof or other ceramic material, being supplied to the flame. The settings for the supply of oxygen and acetylene all maintained as above. The shielding fluid feed pressure is chosen in a range from 0.1 bars to 3 bars. The powder material supply or feed mass flow is chosen in a range from 12 g/min to 30 g/min. The flame spraying process is carried out with the working distance from an exit of the spray device to the workpiece surface between 80 mm and 180 mm and a step size between 2 mm and 8 mm. A non-metallic coating layer is thus manufactured on the rough metallic coating layer which is suitable as a thermal barrier coating. Dependent on the specific parameter settings, the resulting non-metallic coating layer may be characterized as a porous thermal barrier coating or a dense vertical-cracked thermal barrier coating.

For another instance, it may be desired to dispose an environmental barrier coating layer on the metallic coating layer. In this instance, the flame spraying process is in a subsequent process phase carried out with a powder material consisting of alumina being provided to the flame. The settings for the supply of oxygen and acetylene all maintained as above. The shielding fluid feed pressure is chosen in a range from 1 bar to 3 bars. The powder material feed mass flow is chosen in a range from 15 g/min to 30 g/min. The flame spraying process is carried out with the working distance from an exit of the spray device to the workpiece surface between 80 mm and 140 mm and a step size between 2 mm and 5 mm. A non-metallic coating layer is thus manufactured on the rough metallic coating layer which is suitable as an environmental barrier coating.

For a further instance, it may be desired to dispose an abradable coating layer on the metallic coating layer. In this instance, the flame spraying process is in a subsequent process phase carried out with a powder material consisting of alumina being provided to the flame. The settings for the supply of oxygen and acetylene all maintained as above. The shielding fluid feed or supply pressure is chosen in a range from 1.5 bars to 5 bars. The powder material feed mass flow is chosen in a range from 20 g/min to 32 g/min. The flame spraying process is carried out with the working distance from an exit of the spray device to the workpiece surface between 50 mm and 100 mm and a step size between 3 mm and 8 mm. A non-metallic coating layer is thus manufactured on the rough metallic coating layer which is suitable as an abradable coating.

The exemplary embodiments of carrying out the method given above impressively demonstrate how easily the method enables to influence the characteristics of the resulting coating when applying the same material in simply choosing different operating parameter sets.

In other aspects, it may be desired to dispose a hardface coating layer on the substrate. In this instance, the flame spraying process is carried out with a powder material consisting of an Cr3C2-NiCr 75/25 chromium carbide material being provided to the flame. The settings for the supply of oxygen and acetylene all maintained as above. The shielding fluid feed pressure is chosen in a range from 2 bars to 4 bars. The powder material feed mass flow is chosen in a range from 45 g/min to 65 g/min. The flame spraying process is carried out with the working distance from an exit of the spray device to the workpiece surface between 100 mm and 220 mm and a step size between 8 mm and 2 mm.

It is noted that the entire refurbishing process described above may in particular be carried out manually, with the spray device hand-held and -guided.

While the subject matter of the disclosure has been explained by means of exemplary embodiments, it is understood that these are in no way intended to limit the scope of the claimed invention. It will be appreciated that the claims cover embodiments not explicitly shown or disclosed herein, and embodiments deviating from those disclosed in the exemplary modes of carrying out the teaching of the present disclosure will still be covered by the claims.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for manufacturing a coating on a component, the method comprising
providing an oxidizer fluid flow and a combustion fluid flow to a spray device, combusting the combustion fluid flow with the oxidizer fluid flow, thereby generating a flame emanating from the spray device,
providing a shielding fluid flow around the flame,
supplying a supply mass flow of powder material into the flame, thus providing a flow of molten material inside the flame, and
directing the flame towards a surface of a workpiece, thereby depositing the molten material on the surface and generating a coating, wherein the flow of powder material which is supplied into the flame comprises a metal, thereby generating a metallic coating layer, and setting the process parameters, while a powder material is supplied into the flame which comprises a metal, such as to generate a metallic coating layer with a surface arithmetic mean roughness value Ra equal to or larger than 10 microns.

2. The method according to claim 1, wherein the working distance from an exit of the spray device to the workpiece surface is in a range from equal to or larger than 160 mm and smaller than or equal to 240 mm when generating the metallic coating layer.

3. The method according to claim 1, wherein the powder material supply mass flow is equal to or larger than 40 g/min and smaller than or equal to 70 g/min when generating the metallic coating layer.

4. The method according to claim 3, wherein applying a subsequent process phase subsequent to generating the metallic coating layer, which comprises selecting a further powder material to be provided to the flame and supplying a supply mass flow of said further powder material into the flame, and directing the flame towards the surface of the previously generated layer, thereby generating a further coating layer on the previously generated coating layer, wherein the further powder material comprises a non-metallic material.

5. The method according to claim 1 in which a subsequent process phase is claimed, wherein the further powder material comprises a thermal barrier coating material, and the working distance from the spray device to the workpiece surface is chosen in a range from equal to or larger than 80 mm and smaller than or equal to 140 mm during the subsequent process phase, whereby the resulting further coating layer is intended as a porous thermal barrier coating.

6. The method according to claim 1 in which a subsequent process phase is claimed, wherein the further powder material comprises a thermal barrier coating material, and during the subsequent process phase the powder material supply mass flow is equal to or larger than 15 g/min and smaller than or equal to 30 g/min, whereby the resulting further coating layer is intended as a porous thermal barrier coating.

7. The method according to claim 1 in which a subsequent process phase is claimed, wherein the further powder material comprises a thermal barrier coating material and the working distance from the spray device to the workpiece surface is chosen in a range from equal to or larger than 50 mm and smaller than or equal to 180 mm during the subsequent process phase, whereby the resulting further coating layer is intended as a dense vertical-cracked thermal barrier coating.

8. The method according to claim 1 in which a subsequent process phase is claimed, wherein the further powder material comprises a thermal barrier coating material and during the subsequent process phase the powder material supply mass flow is equal to or larger than 12 g/min and smaller than or equal to 18 g/min, whereby the resulting further coating layer is intended as a dense vertical-cracked thermal barrier coating.

9. The method according to claim 1 in which a subsequent process phase is claimed, wherein the further powder material comprises an abradable coating material and the working distance from the spray device to the workpiece surface is chosen in a range from equal to or larger than 50 mm and smaller than or equal to 100 mm during the subsequent process phase, whereby the resulting further coating layer is intended as an abradable coating.

10. The method according to claim 1 in which a subsequent process phase is claimed, wherein the further powder material comprises an abradable coating material and during the subsequent process phase the powder material supply mass flow is equal to or larger than 20 g/min and smaller than or equal to 32 g/min, wherein the resulting further coating layer is intended as an abradable coating.

11. The method according to claim 1 in which a subsequent process phase is claimed, wherein the further powder material comprises an environmental barrier coating material and the working distance from the spray device to the workpiece surface is chosen in a range from equal to or larger than 80 mm and smaller than or equal to 140 mm during the subsequent process phase, whereby the resulting further coating layer is intended as an environmental barrier coating.

12. The method according to claim 1 in which a subsequent process phase is claimed, wherein the further powder material comprises an environmental barrier coating material and during the subsequent process phase the powder material supply mass flow is equal to or larger than 15 g/min and smaller than or equal to 30 g/min, whereby the resulting further coating layer is intended as an environmental barrier coating.

13. The method according to claim 1, wherein the method is performed on a locally restricted surface area of the component.

14. The method according to claim 1, wherein the method is performed on site.

15. The method according to claim 1, wherein the method is performed manually.
